(19) United States
(12) Patent Application Publication
(10) Pub. No.: US 2002/0078034 A1
(43) Pub. Date: Jun. 20, 2002

(54) Query system and method thereof

(75) Inventors: Chun-Hong Cho, Taipei (TW); Tse-Ming Tsai, Taipei Hsien (TW)

Correspondence Address: DARBY & DARBY P.C., 805 Third Avenue, New York, NY, 10022, US

(73) Assignee: Institute for Information Industry

(21) Appl. No.: 09/780,238

(22) Filed: Feb. 9, 2001

(30) Foreign Application Priority Data
Dec. 18, 2000 (TW) 89127085

(51) Int. Cl. G06F 7/00; G06F 17/30

(52) U.S. Cl. 707/3

(57) ABSTRACT

An query system comprises a main computer, a query computer, and an expert computer. The main computer writes query data into a database, searches the database using the query data as search forms to obtain a first answer, transmits the first answer to the query computer via a first network, transmits the query data to the expert computer via a second network, receives the second answer from the expert computer, writes the second answer into the database and transmits a second answer to the query computer via the first network. The query computer connects the main computer via the first network for inputting the query data, transmitting the query data to the main computer across the first network and receiving the first and second answers. The expert computer connects the main computer via the second network for receiving the query data, then transmits a second answer from the expert computer to the main computer.

### BACKGROUND OF THE INVENTION

1. Field of the Invention

The present invention relates to a query system and method thereof, and more particularly to a query system and method through a network.

2. Background

Most of the query systems use a single function to let an inquirer ask a question and let another person answer. Due to lack of informing mechanism, if one is not check oneself, one can not find one's problem has been solved. Meanwhile, technology of the query systems is distributed in the branches of a network and the branches of a company, and therefore results in the waste of the technology and available resources.

Frequently asked questions (FAQ) is built in each Web station, but the available information and experience gradually get lost when time goes by, or the available information and experience are not stored and classified well, resulting in loss. Moreover, in these various query systems, computers manage the information, but there are still many parts that are operated and analyzed manually. Thus the cost of the query systems is high and the efficiency cannot be elevated.

The conventional query systems usually use an expert to solve the problems of many people, or via a single window using manual classification, if a problem belongs to X department, the problem is sent to X department and then is transferred to the expert for a solution. Thus, human resources are wasted and this results in bad efficiency and unnecessary expense.

Furthermore, in the conventional query systems, the problems of the inquirers are not classified well, thus the former problems are pushed down causing inconvenience for the inquirers.

### SUMMARY OF THE INVENTION

The object of the present invention is to solve the above-mentioned problems and to provide a query system and method thereof to build management knowledge and an expert query system.

According to the present invention, a query system that comprises a main computer, a query computer, and an expert computer. The main computer writes query data into a database, searches the database using the query data as search forms to obtain a first answer, transmits the first answer to the query computer via a first network, transmits the query data to the expert computer via a second network, receives the second answer from the expert computer, writes the second answer into the database and transmits a second answer to the query computer via the first network. The query computer connects the main computer via the first network for inputting the query data, transmits the query data to the main computer across the first network and receives the first and second answers. The expert computer connects the main computer via the second network for receiving the query data, transmitting a second answer from the expert computer to the main computer.

According to the present invention, an query method suitable for a system consisting of a main computer, a query computer and an expert computer comprising the steps of: inputting query data into the query computer, transmitting query data from the query computer to the main computer across a first network; searching a database provided in the main computer using the query data as search forms to obtain a first answer, transmitting the first answer from the main computer to the query computer via the first network; transmitting the query data from the main computer to the expert computer across a second network if the first answer is unsatisfactory; transmitting a second answer from the expert computer to the main computer and writing the second answer into the database in the main computer; and transmitting the second answer to the query computer via the first network.

### BRIEF DESCRIPION OF THE DRAWINGS

The present invention will be described in detail with reference to the illustrated embodiments and the accompany drawings, in which:

FIG. 1 is a block diagram of the query system in the preferred embodiment.

FIG. 2 is a flow chart showing the steps for the query procedures in the preferred embodiment.

FIG. 3 illustrates a “PROBLEM SELECTION WINDOW” screen in the preferred embodiment.

### DETAILED DESCRIPTION OF THE PREFERRED EMBODIMENT

An query system and method thereof according to the preferred embodiment of the present invention will now be described.

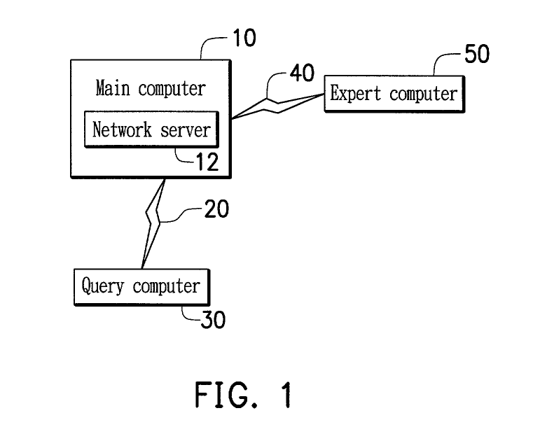

FIG. 1 is a block diagram of the query system in the preferred embodiment. As shown in FIG. 1, the query system includes a main computer 10, a query computer 30 and an expert computer 50. The main computer 10 includes a network server 12. The main computer 10 and the query computer 30 are linked via a first network 20, such as the Internet, a local area network (LAN), a wide area network (WAN) or the other types of networks. Then, the expert computer 50 and the main computer 10 are linked via a second network 40, such as by the Internet, a local area network, a wide area network or the other types of networks. The main computer 10 can be any type of computer system or a series of computers or servers. The main computer 10 can have functions of the network server 12.

The main computer 10 in the preferred embodiment provides an input screen for inputting query data, writes the query data into a database, according to the query data provides a first answer, receives and sends a second answer, and writes the second answer into the database. The query computer 30 via the first network 20 connects to the main computer 10 for inputting the query data, and receives the first answer and the second answer. The expert computer 50 via the second network 40 connects to the main computer 10 for receiving the query data, and provides the second answer to the main computer 10. In FIG. 1, only one query computer 30 and one expert computer 50 using query system are illustrated for simplification. However, it is understood by those skilled in the art that the system can concurrently serve a plurality of query computers and expert computers to perform the query procedures described later.

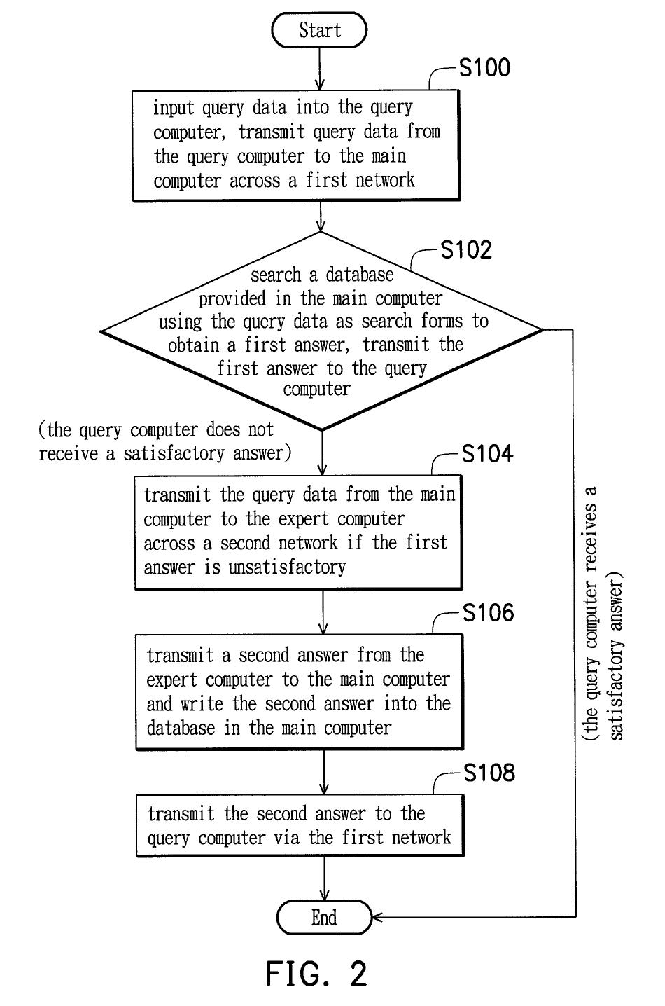

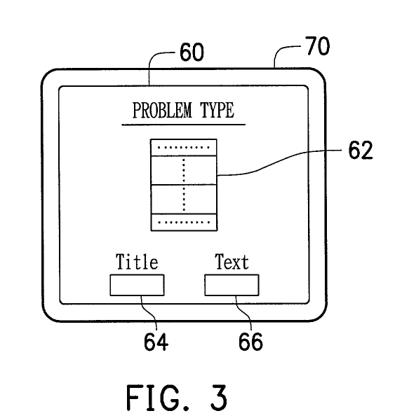

Refer to FIG. 2. A flow chart showing the steps for the query procedures in this invention is illustrated. The process first starts with the main computer 10 via a first network 20, which provides an input screen 60 (as shown in FIG. 3) for the query computer 30 to input query data, then the query computer 30 transmits query data to the main computer 10 across the first network 30 as shown in step S100. FIG. 3 illustrates a face 70 of a display monitor that is displaying a “PROBLEM SELECTION WINDOW” screen 60 in accordance with an embodiment of the present invention. In the exemplary embodiment, “PROBLEM TYPE” column 62 can be selected by a user utilizing a pointing device such as a mouse. After the user has finished making the selections, the user keying the “Title” space 64 and the “Text” space 64 illustrated in screen 60. Key words can be provided after keying the “Title” space 64 and the “Text” space 64. The usage of the key words is that the user utilizes a pointing device such as a mouse marking a key word that the user thinks, then the system will automatically use a certain symbol to mark the key word. Furthermore, the user can search an answer for his problem from the database before input the query data (not shown). If the user finds a right answer for his problem, the process can terminate.

In step S102, the main computer 10 writes the query data into a database and searches the database using the query data as search forms to obtain a first answer, then the main computer 10 transmits the first answer to the query computer 30 via the first network 20. In the exemplary embodiment, the key words mentioned in the above step can be used to search the first answer from the database by the main computer 10. If the first answer is found, the process terminates; otherwise step S104 is executed.

In step S104, the main computer 10 via a second network 40 transmits the query data to the expert computer 50. The method of informing the expert computer 50 can be performed by e-mail.

In step S106, the expert computer 50 via the second network 40 provides a second answer to the main computer 10 and writes the second answer into the database. This step further comprises a step of the main computer 10 sending an acknowledgement to the expert computer 50 after the main computer 10 has received the second answer.

Finally, In step S108, the main computer 10 via the first network 20 transmits the second answer to the query computer 30.

An advantage of the present invention is that the query system can provide and send related answers to a problem of an inquirer to the inquirer. If the answers are right for the inquirer, the problem is solved; otherwise the query system passes the problem to an expert, thus can increase the successfully solved rate of problems in the query system. Furthermore, if a problem of an inquirer is solved after a long time, the query system can also reply to the inquirer through the Internet quickly, easily, anywhere and anytime. Moreover, the query system can integrate the available resources and various experts, and reduces the solved time of a problem.

While the invention has been described with reference to various illustrative embodiments, the description is not intended to be construed in a limiting sense. Various modifications of the illustrative embodiments, as well as other embodiments of the invention, will be apparent to those persons skilled in the art upon reference to this description. It is therefore contemplated that the appended claims will cover any such modifications or embodiments as may fall within the scope of the invention defined by the following claims and their equivalents.

What is claimed is:

1. A query system comprising:
a main computer;
a query computer; and
an expert computer;
wherein the main computer writes query data into a database, searches the database using the query data as search forms to obtain a first answer, transmits the first answer to the query computer via a first network, transmits the query data to the expert computer via a second network, receives the second answer from the expert computer, writes the second answer into the database and transmits a second answer to the query computer via the first network;
the query computer connects the main computer via the first network for inputting the query data, transmitting the query data to the main computer across the first network and receiving the first and second answers; and
the expert computer connects the main computer via the second network for receiving the query data, transmitting a second answer from the expert computer to the main computer.

2. The system as recited in claim 1, wherein the main computer further comprises a network server.

3. The system as recited in claim 1, wherein the first network and the second network are selected from the group consisting of the Internet, local area networks, and wide area networks.

4. An query method suitable for a system consisting of a main computer, a query computer and an expert computer comprising the steps of:
inputting query data into the query computer, transmitting query data from the query computer to the main computer across a first network;
searching a database provided in the main computer using the query data as search forms to obtain a first answer, transmitting the first answer from the main computer to the query computer via the first network;
transmitting the query data from the main computer to the expert computer across a second network if the first answer is unsatisfactory;
transmitting a second answer from the expert computer to the main computer and writing the second answer into the database in the main computer; and
transmitting the second answer to the query computer via the first network.

5. The method as recited in claim 4, wherein the step of said main computer passing the query data to the expert computer comprises sending an e-mail.

6. The method as recited in claim 4, wherein the step of the main computer sending the second answer to the query computer comprises sending an e-mail.

7. The method as recited in claim 4, further comprising the step of the main computer sending an acknowledgement to the expert computer after the main computer has received the second answer.
